(19) United States
(12) Patent Application Publication
(10) Pub. No.: US 2024/0424698 A1
(43) Pub. Date: Dec. 26, 2024

(54) MOUNTING ASSEMBLY FOR A HAIR CUTTING APPLIANCE

(71) Applicant: KONINKLIJKE PHILIPS N.V., EINDHOVEN (NL)

(72) Inventors: MARCUS CORNELIS PETRELLI, GRONINGEN (NL); ALWIN DE VRIES, ZUIDLAREN (NL); THEODOOR RENÉ MARIA HIN, EMMEN (NL)

(21) Appl. No.: 18/684,537

(22) PCT Filed: Aug. 9, 2022
(86) PCT No.: PCT/EP2022/072305

§ 371 Date: Feb. 16, 2024

(30) Foreign Application Priority Data
Aug. 19, 2021 (EP) 21192092.1

(51) Int. Cl. B26B 19/04; B26B 19/06

(52) U.S. Cl. CPC B26B 19/048; B26B 19/063

(57) ABSTRACT

According to an aspect, there is provided a mounting assembly (20) for a hair cutting appliance (10), the mounting assembly comprising: a base (22) and a head (24), the head comprising a body (26) and a driving bridge (28) and being configured to receive a cutting unit (14), wherein the driving bridge is configured to couple to the cutting unit and to reciprocally move relative to the body; a pivoting mechanism (60) disposed between the head and the base and configured to permit pivoting movement of the head relative to the base about a primary axis (50) and a secondary axis (70); and a driving unit (40) comprising a frame (42) and a driving axle (44), wherein the driving axle is rotatable relative to the frame about an elongate axis of the driving axle, and the frame provides a bearing surface (52) for the driving axle; wherein the frame comprises a body coupling (54) which is configured to couple to the body of the head to permit pivoting movement of the head relative to the frame about a body pivot axis (56) which is parallel to the primary pivot axis, and wherein the driving unit comprises a base coupling (58) which is configured to couple to the base to permit pivoting movement of the frame relative to the base about a base axis (62) which is parallel to the secondary axis; wherein the driving axle comprises: an eccentric driving pin (46) at a distal end of the driving axle, the eccentric driving pin configured to interact with the driving bridge to induce reciprocating movement to the driving bridge relative to the body of the head; and a socket (48) on a proximal end of the axle for engaging with a driving head (19) on a motor axle (18) for rotary transmission.

### FIELD OF THE INVENTION

The invention relates to a mounting assembly for a hair cutting appliance and a hair cutting appliance.

### BACKGROUND OF THE INVENTION

Hair cutting appliances which have heads which can pivot about an axis relative to handles to follow contours of an object, such as a user's face are known. Some hair cutting appliances have heads which can pivot about two axes relative to a handle, but this presents difficulties in electric hair cutting appliances in transferring the motion from a motor in a handle to a blade in a head which is pivotable about two different axes.

US 2018/085935 discloses to an electric shaver with a first cutter element and a second cutter element which are movable relative to each other in an oscillating manner along a first horizontal cutter oscillation axis. Each cutter unit is mounted in the cartridge pivotably about a second horizontal tilting axis and axially displaceable parallel to a vertical axis. The first horizontal cutter oscillation axis is perpendicular to the vertical axis and perpendicular to the second horizontal tilting axis. It comprises a drive shaft which drives oscillating motion of one of the cutter elements.

### SUMMARY OF THE INVENTION

According to a first specific aspect, there is provided a mounting assembly for a hair cutting appliance, the mounting assembly comprising: a base and a head, the head comprising a body and a driving bridge and being configured to receive a cutting unit, wherein the driving bridge is configured to couple to the cutting unit and to reciprocally move relative to the body; a pivoting mechanism disposed between the head and the base and configured to permit pivoting movement of the head relative to the base about a primary axis and a secondary axis; and a driving unit comprising a frame and a driving axle, wherein the frame is rotatable relative to the driving axle about an elongate axis of the driving axle, and provides a bearing surface for the driving axle; wherein the frame comprises a body coupling which is configured to couple to the body of the head to permit pivoting movement of the head relative to the frame about a body pivot axis which is parallel to the primary pivot axis, and wherein the driving unit comprises a base coupling which is configured to couple to the base to permit pivoting movement of the frame relative to the base about a base axis which is parallel to the secondary axis; wherein the driving axle comprises: an eccentric driving pin at a distal end of the driving axle, the eccentric driving pin configured to interact with the driving bridge to induce reciprocating movement to the driving bridge relative to the body of the head; and a socket on a proximal end of the axle for engaging with a driving head on a motor axle for rotary transmission.

The primary axis and the secondary axis may be perpendicular.

The frame may comprise the base coupling which is configured to couple to the base to permit pivoting movement of the frame relative to the base about the base axis.

The base axis may be a secondary base axis; and wherein the base coupling may be further configured to couple to the base to permit pivoting movement of the frame relative to the base about a primary base axis which is parallel to the primary axis.

The base coupling may be further configured to translate in a direction away from, or towards, the head.

The frame may comprise a protrusion which acts as the base coupling, and which is configured to cooperate with a channel in the base extending away from the head, to permit pivoting movement of the frame relative to the base about the primary base axis, and to permit translating movement of the protrusion along the slot or channel.

There may be two opposing protrusions which each cooperate with respective opposing channels in the base. The protrusion may be a pin configured to cooperate with a slot in the base.

The base coupling may be configured such that the pin of the base coupling is disposed within the slot, and such that the pin can be translated along the slot to accommodate pivoting movement of the head about the primary axis, and into and out of the slot to permit pivoting movement about the secondary base axis.

The two opposing protrusions may define a surface curved in a plane perpendicular to the primary axis which interfaces with, and bears against, the channel to permit pivoting movement of the base coupling about the primary base axis.

The base coupling may comprise a void between the frame and the base so as not to obstruct pivoting movement about the secondary base axis, thereby permitting pivoting movement about the secondary base axis.

The pivoting mechanism may comprise a four-bar linkage comprising two arms pivotably disposed between the head and the base such that each of the head, the base and each arm is one arm of the four-bar linkage, such that the primary axis is a virtual axis.

The frame may comprise a pair of opposing body couplings which are configured to permit pivoting movement of the frame relative to the head about the body pivot axis which passes through both body couplings.

The body couplings of the frame may each comprise an arm, each arm having a distal pin or a hole, the pin or hole cooperating with a corresponding hole or pin in the body of the head to permit pivoting movement about the body pivot axis through the pins and holes, and wherein the arms are configured such that they are held under pretension to push the respective pins and holes together. The frame may be suspended from the body of the head at the body couplings.

According to a second aspect, there is provided a hair cutting appliance comprising a mounting assembly according to the first aspect, and a handle fixed to the base of the mounting assembly, the handle comprising a motor to rotate an elongate motor axle, the elongate motor axle comprising a driving head at a distal end which is coupled to the socket of the driving axle of the mounting assembly to form an articulated joint configured to transfer rotary motion from the motor axle to the driving axle, and configured to permit pivoting movement between the motor axle and the driving axle.

These and other aspects will be apparent from and elucidated with reference to the embodiment(s) described hereinafter.

### BRIEF DESCRIPTION OF THE DRAWINGS

Exemplary embodiments will now be described, by way of example only, with reference to the following drawings, in which:

FIG. 1 schematically shows an isometric view of a hair cutting appliance;

FIGS. 2A, 3A, 4A and FIGS. 2B, 3B, 4B respectively show a side view and a cross-sectional view of a first example mounting assembly in a neutral position, a first contour following position and a second contour following position;

FIG. 5 schematically shows an isometric cutaway view of a second example mounting assembly;

FIG. 6 schematically shows a cross-sectional view of a third example mounting assembly; and

FIG. 7 schematically shows an isometric view of a driving unit of the third example mounting assembly.

### DETAILED DESCRIPTION OF EMBODIMENTS

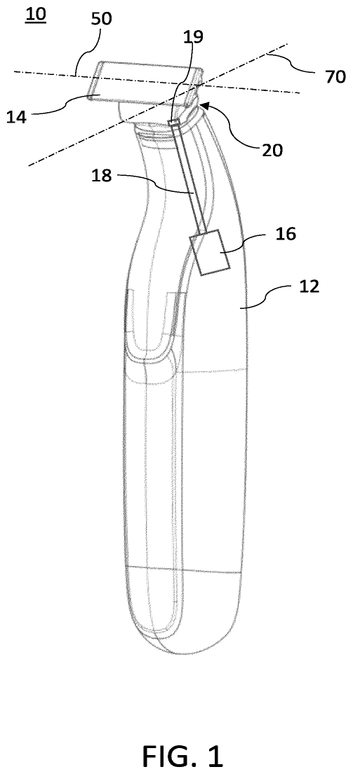

FIG. 1 shows a hair cutting appliance 10 comprising a handle 12, a mounting assembly 20 fixed to the handle 12 and a cutting unit 14 received on the mounting assembly 20. The mounting assembly 20 is configured to enable pivoting movement about a primary axis 50 of the cutting unit 14 relative to the handle 12. The mounting assembly 20 further enables pivoting movement of the cutting unit 14 about a secondary axis 70 relative to the handle 12, the secondary axis 70 being perpendicular to the primary axis 50, such that the cutting unit 14 is pivotable about two perpendicular axes with respect to the handle 12.

In this example, the primary axis 50 and the secondary axis 70 are skew lines (i.e. they do not intersect one another and are not parallel). In some examples, the primary axis and the secondary axis may be orthogonal (i.e. they may be perpendicular and intersect one another). In other examples, the primary axis and the secondary axis may not be perpendicular, but they are not parallel.

In this example, the handle 12 comprises a motor 16 to rotate an elongate motor axle 18 about an elongate axis of the motor axle 18. The motor axle 18 comprises a driving head 19 at a distal end thereof which is configured to couple with the mounting assembly 20, to transfer rotary motion from the motor axle 18 to a part of the mounting assembly 20.

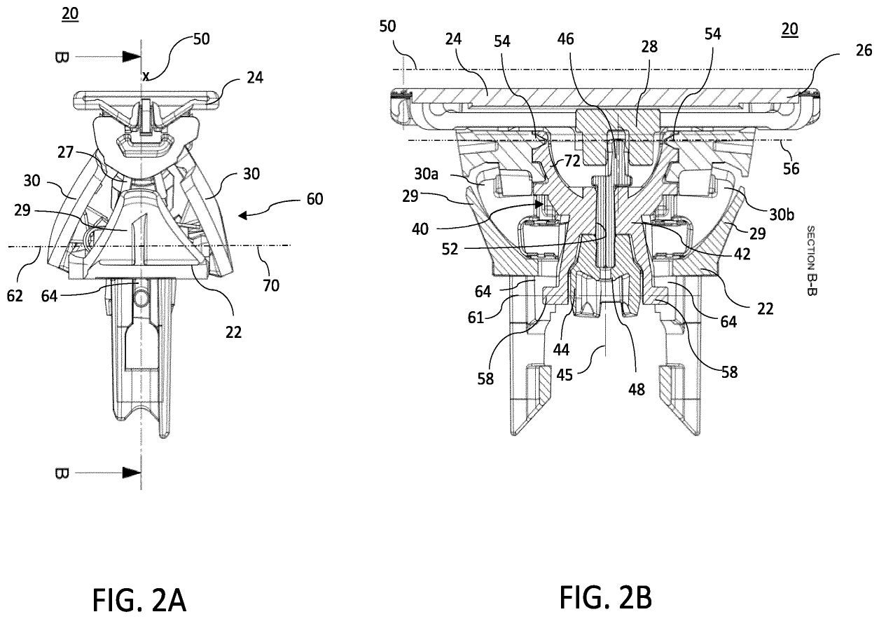

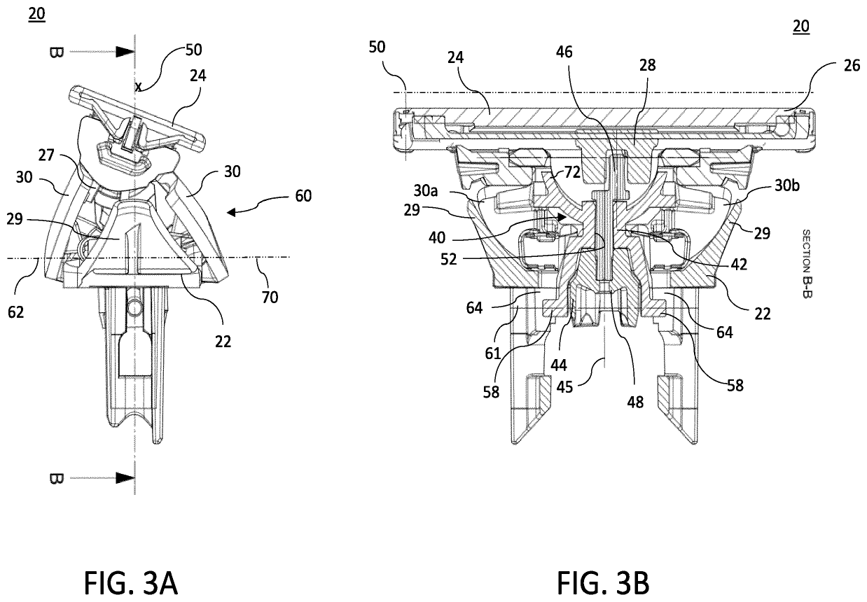

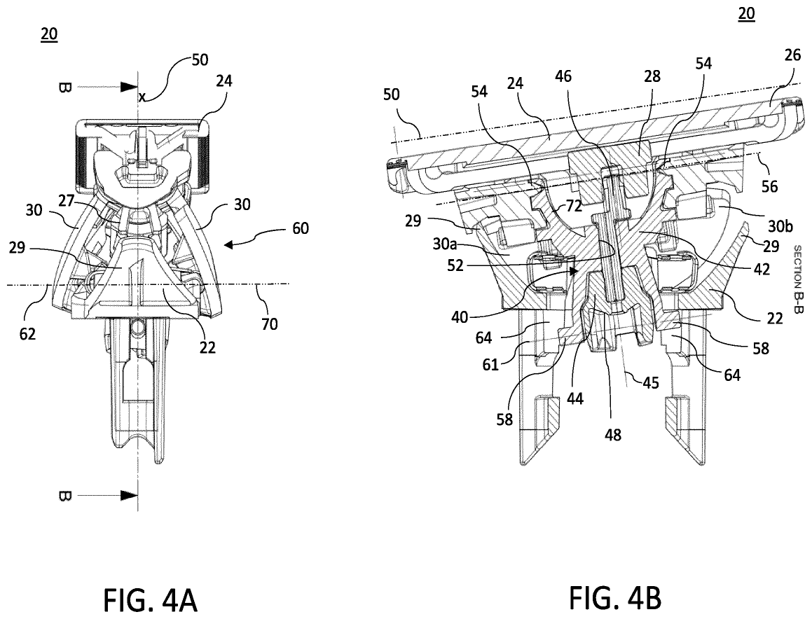

FIG. 2A shows a side view of a first example mounting assembly 20 in a neutral position and FIG. 2B shows a cross-sectional view of the first example mounting assembly in the neutral position. FIGS. 3A and 3B show the same views as FIGS. 2A and 2B respectively, with the mounting assembly 20 in a first contour following position, in which the cutting unit 14 is pivoted, from the neutral position, relative to the handle 12 about the primary axis 50. FIGS. 4A and 4B also shows the same views as FIGS. 2A and 2B respectively, with the mounting assembly 20 in a second contour following position, in which the cutting unit 14 is pivoted, from the neutral position, relative to the handle 12 about the secondary axis 70.

The mounting assembly 20 comprises a base 22 which is configured to attach to the handle 12, and a head 24 which is configured to receive the cutting unit 14 (not shown in FIGS. 2A-4B), such as a blade. The head 24 comprises a body 26 and a driving bridge 28 (shown in FIGS. 2B, 3B and 4B). The driving bridge 28 is configured to move reciprocally, by translation, relative to the body 26, and is configured to couple to the cutting unit 14. When coupled to the driving bridge 28, the cutting unit 14 can therefore also move reciprocally relative to the body 26 within a plane of the cutting unit 14. The body 26 may comprise a counteracting blade such that the cutting unit 14 together with the counteracting blade on the body 26 can cut hairs.

A pivoting mechanism 60 is disposed between the base 22 and the head 24 and is configured to permit pivoting movement of the head 24 relative to the base 22 about the primary axis 50 and the secondary axis 70.

In this example, the pivoting mechanism comprises a pair of arms 30 pivotably disposed between the base 22 and the head 24. In other words, each arm 30 is pivotably coupled to the base 22 at one end and is pivotably coupled to the head 24 at another end to form a four-bar linkage in which the head 24 forms one bar, the base 22 forms one bar and each arm 30 forms one bar of the four-bar linkage. The four-bar linkage permits pivoting movement of the head 24 about the primary axis 50, which is a virtual axis on an opposing side of the head 24 to the arms 30.

In this example, each arm 30 comprises two diverging strands 30a, 30b to form a U-shape such that the two ends of each U-shape are connected to the head 24. The head 24 is therefore supported by the arms 30 at four points in total. The apex of each U-shaped arm is connected to the base 22 with a ball and socket joint (not shown) to further permit pivoting movement of the arms 30 and the head 24 in unison relative to the base about the secondary axis 70. The primary axis 50 therefore also moves about the secondary axis 70 when the four-bar linkage is pivoted about the secondary axis 70.

In other examples, each arm may comprise a single strand to form an I-shape such that the head is supported by the arms at only two points in total, or the arms may comprise more than two diverging strands so that the head is supported by the arms at more than two points per arm. Each arm may have a different number of diverging strands to support the head at, for example 3 or 5 points. In yet further examples, the arms may comprise two diverging strands in the form of a T, V or Y shape such that each arm supports the head at two points. The arms may alternatively be inverted so that the ball and socket joint is between the arms and the head.

It will be appreciated that the pivoting mechanism may include any suitable mechanism for permitting pivoting of the head relative to the handle about two different axes. In some examples, instead of a four-bar linkage, the pivoting mechanism may comprise a simple pivot between the head and the base to permit pivoting movement of the head about the primary axis with respect to the base, and a further simple pivot between the head and the base to permit pivoting movement of the head about the secondary axis with respect to the base. In other examples, the pivoting mechanism may comprise ball and socket joints to simultaneously permit pivoting movement of the head about both the primary axis and the secondary axis.

The mounting assembly 20 further comprises a driving unit 40 which is configured to drive the reciprocating movement of the driving bridge 28. The driving unit 40 comprises a frame 42 and a driving axle 44.

The driving axle 44 extends along an elongate axis 45 and comprises an eccentric driving pin 46 at a distal end of the driving axle 44, which is offset from the elongate axis 45. The eccentric driving pin 46 is configured to interact with the driving bridge 28 to induce reciprocating movement of the driving bridge 28 relative to the body 26. In other words, the driving bridge 28 comprises a channel in which the eccentric driving pin 46 is loosely received so that the driving pin 46 can move up and down the channel freely. Rotation of the driving axle 44 therefore induces movement of the driving pin 46 in circles, which transfers linear motion to the driving bridge 28 since the driving pin 46 is freely moveable along the channel but pushes the channel back and forth in a direction perpendicular to the extent of the channel.

The driving axle 44 also comprises a socket 48 at a proximal end for engaging with the driving head 19 on the motor axle 18 in the handle 12 for rotary transmission. Rotary motion of the driving axle 44 (about the elongate axis 45), which is transferred from the motor axle 18 to the driving axle 44, via the socket 48, is therefore converted into reciprocating linear motion of the driving bridge 28 due to the interaction of the eccentric pin 46 with the driving bridge 28.

The socket 48 is configured to engage with the driving head 19 of the motor axle 18 such that the motor axle 18 and the driving axle 44 can pivot up to 30 degrees relative to one another whilst still transferring rotary motion from the motor axle to the driving axle 44. Such a coupling is described in patent application publication number US 2003/019107, which is incorporated herein by reference.

The body 26 of the head 24 comprises a stroke limiter 27 projecting towards the base 22 and configured to abut an arm 30 of the four-bar linkage when the head 24 is pivoted approximately 20 degrees about the primary axis 50 from the neutral position in either direction, such as shown in FIG. 3A. This prevents pivoting of the driving axle 44 relative to the motor axle 18 by more than 30 degrees to ensure that they do not decouple. It will be appreciated that in some examples, the stroke limiter may be configured to abut an arm at any suitable angle. In other examples, there may be no stroke limiter or the stroke limiter may be disposed on the base and configured to abut the arms, or may be disposed on the arms and configured to abut the head or the base.

The base 22 comprises a pair of stops 29. each projecting towards the head 24. Each stop 29 is configured to abut the body 26 when the head 24 is pivoted approximately 8 degrees about the secondary axis 70 from the neutral position in both directions, as shown in FIG. 4B. This also prevents pivoting of the driving axle 44 relative to the motor axle 18 by more than 30 degrees to ensure that they do not decouple. It will be appreciated that, in some examples, each stop may be configured to abut the body at any suitable angle. In other examples, there may be no stops, or the stops may be configured to abut the arms of the four-bar linkage, or may be disposed on the arms or head and configured to abut the base.

A combination of movements about both the primary axis 50 and the secondary axis 70 can therefore be made without decoupling of the driving axle 44 and the motor axle 18, since the movements about both axes are constrained.

The frame 42 surrounds at least part of the driving axle 44 and is rotatable relative to the driving axle 44 about the elongate axis 45. The frame 42 provides a bearing surface 52 for the driving axle 44 to rotate relative to the frame 42.

The frame 42 comprises a pair of body couplings 54 on opposing sides at a distal end of the frame 42, the body couplings 54 being configured to couple with the body 26 of the head 24 to permit pivoting movement of the head 24 relative to the frame 42 about a body pivot axis 56, which is parallel to the primary axis 50.

In this example, the body couplings 54 each comprise an arm 72 extending towards the body 26 and comprising a hole, which hole cooperates with a pin in the body 26. In other examples, each arm may comprise a pin which cooperates with a corresponding hole in the body.

The body pivot axis 56 passes through both body couplings 54 in this example (i.e., through both holes and pins). In other examples, there may be only a single body coupling which pivotably couples the frame to the body of the head. In this example, the arms 72 of the frame 42 are held under pretension in order to push the pin of the body 26 into the hole of the body coupling 54. Such pretension therefore removes the need for other forms of reliably securing the frame and body together, such as screws for example, and removes any play between the body 26 and the frame 42 which would otherwise lead to a loss of effective stroke of the cutting unit 14. The pretensioned arms therefore improve the case of assembly.

In this example, the frame 42 also comprises a pair of opposing base couplings 58 which are configured to couple to the base 22 to permit pivoting movement of the frame 42 relative to the base 35 about a primary base axis 61 which is parallel to the primary axis 50, and a secondary base axis 62 which is parallel to the secondary axis 70. In this example, the secondary base axis 62 is the same as the secondary axis 70. In other examples, the secondary base axis may not be the same as the secondary axis.

The frame 42 comprises a pair of protrusions in the form of pins which act as the base couplings 58. The pins are received within corresponding opposing slots 64 in the base 22, which slots 64 extend in a direction away from the head 24. The pins are configured to cooperate with the slots 64 to permit translation of the pins away from, and towards, the head 24, along the respective slots 64. The pins cooperate with the slots 64 further to permit pivoting movement of the frame 42 relative to the base 22 about the primary base axis 61, which passes through both of the pins. The pins also permit movement about the secondary base axis 62 by moving into and out of the slots 64 and translating along the slots 64, as shown in FIG. 4B.

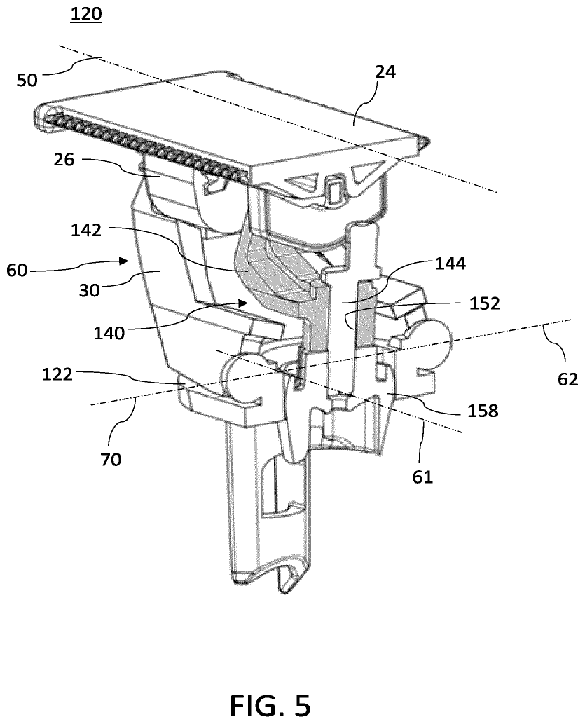

In some examples, there may be only a single base coupling, and the base coupling may permit pivoting movement of the frame relative to the base about only the secondary base axis. For example, in examples whether the movement of the head about the primary axis is facilitated by a simple pivot, there may be no need for the base coupling to permit pivoting movement about a primary base axis, since movement of the head about the primary axis is already accommodated by the body couplings. In some examples, the base coupling(s) may be disposed on another part of the driving unit, such as the driving axle, as shown in FIG. 5.

Since the frame 42 of the driving unit 40 is coupled to the head 24 at the body pivot axis 56, which is not collinear with the primary axis 50 about which the head 24 pivots relative to the body 26, when the head 24 pivots about the primary axis 50, the base couplings 58 will also move in translation relative to the base 22. The slots 64, which permit translating movement of the pins, therefore accommodate this pivoting movement of the head 24 about the primary axis 50 relative to the base 22 by permitting translating movement of the pins. The frame 42 is suspended from the body 26 of the head 24 at the body couplings 54 (i.e., not directly fixed or attached to the base 22) in order to accommodate such movement. In other words, the base couplings 58 are not directly fixed to the base 22, rather merely constrained to move along the slots 64, such that the frame 42 is only attached to the body 26 of the head 24.

Further, the socket 48 of the driving axle 44 will also translate due to the difference in the body pivot axis 56 and the primary axis 50 and due to the connection to the frame 42. The socket 48 is therefore also configured to accommodate such translating movement relative to the motor axle 18 whilst remaining coupled to the motor axle 18, since the motor axle 18 would not move relative to the handle 12 and would therefore remain stationary relative to the base 22. In other examples, the frame and the driving axle may be configured to translate relative to one another, such that translating movement of the frame relative to the base due to pivoting movement of the head about the primary axis does not mean that the driving axle also moves relative to the base.

Further, the base 22 and the slots 64 have a depth sufficient to permit the pins to move into and out of the slots 64 to permit pivoting movement of the frame about the secondary base axis 62, and thereby to permit pivoting movement of the head 24 about the secondary axis 70.

Therefore, in FIGS. 2A and 2B, with the mounting assembly 20 in the neutral position, the pins of the base couplings 58 are disposed centrally in the slots 64 such that there is space for each pin to translate towards the head 24 and away from the head 24 along the slot 64, and there is space for each pin to move into and out of the slot 64.

In FIGS. 3A and 3B, the mounting assembly 20 is in the first contour following position in which the head 24 is pivoted about the primary axis 50 from the neutral position, such that the pin is marginally translated along the slot 64 to accommodate the pivoting movement of the head about the primary axis 50.

In FIGS. 4A and 4B, the mounting assembly 20 is in the second contour following position in which the head 24 is pivoted about the secondary axis 70 from the neutral position. The movement of the head 24 about the secondary axis 70 causes movement of the frame 42 about the secondary base axis 62, such that one pin has moved outward from the respective slot 64, and the other opposing pin has moved further into the respective slot 64. In this example, it can be seen that the elongate extent of the slot 64 further enables the pivoting movement of the frame 42 about the secondary base axis 62.

Although it has been described that there are slots in the base which receive, and cooperate with, protrusions on the frame, in other examples, the slots may alternatively be channels which do not extend through the thickness of the base.

FIG. 5 shows a second example mounting assembly 120 which is similar to the first example mounting assembly 20 in that it comprises a head 24, a base 122 and a pivoting mechanism 60 in the form of a four-bar linkage having arms 30 which are configured to permit pivoting movement of the head 24 relative to the base 122 about the primary axis 50 and the secondary axis 70. This base 122 in this example differs from the first example base 22 in that it does not comprise slots.

The second example mounting assembly 120 comprises a driving unit 140 which is similar to the driving unit 40 of the first example mounting assembly 20. Specifically, the driving unit 140 of this example comprises a frame 142 and a driving axle 144, where the frame 142 is rotatable relative to the driving axle 144, and which provides a bearing surface 152 for the driving axle 144. The frame 142 comprises body couplings 54 which are similar to the body couplings 54 in the first example mounting assembly 20, and which pivotably couple the frame 142 to the body 26 of the head 24. The frame 142 in this example differs from the first example frame 42 in that it does not comprise the base couplings.

The driving unit 140 of this example differs from the driving unit 40 of the first example mounting assembly 20 in that the driving axle 144 comprises a bearing having a curved outer surface and which has been hollowed out at one end to form the socket 48, similar to the socket 48 of the first example mounting assembly 20. The curved outer surface acts as the base coupling 158 which is configured to permit pivoting movement of the frame 142 relative to the base 122 about a primary base axis 61 and a secondary base axis 62 which, as in the first example mounting assembly 20, are parallel to the primary axis 50 and the secondary axis respectively. The base coupling 158 in this example therefore essentially forms a ball of a ball and socket joint, where the base 122 comprises a hole to receive the base coupling 158 and to permit pivoting movement of the driving axle 144 about the primary base axis 61 and the secondary base axis 62, and therefore of the head 24 relative to the base 122 about the primary axis 50 and the secondary axis 70.

Since there are no protrusions on the curved outer surface of the base coupling 158, the base 122 does not have need a channel or slot to receive such a protrusion.

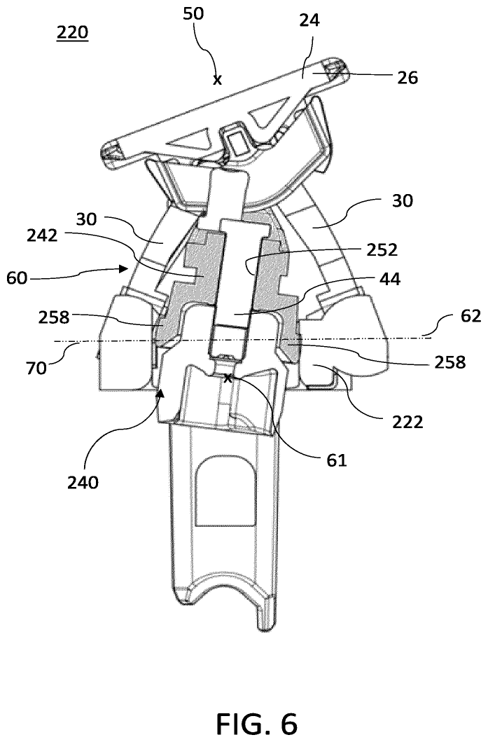

FIG. 6 shows a third example mounting assembly 220 which is similar to the first example mounting assembly 20 and the second example mounting assembly 120 in that it comprises a head 24, a base 222 and a pivoting mechanism 60 in the form of a four-bar linkage having arms 30 which are configured to permit pivoting movement of the head 24 relative to the base 222 about the primary axis 50 and the secondary axis 70. The base 222 in this example differs from the first example base 22 in that it comprises channels which extend away from the head 24, rather than through slots 64.

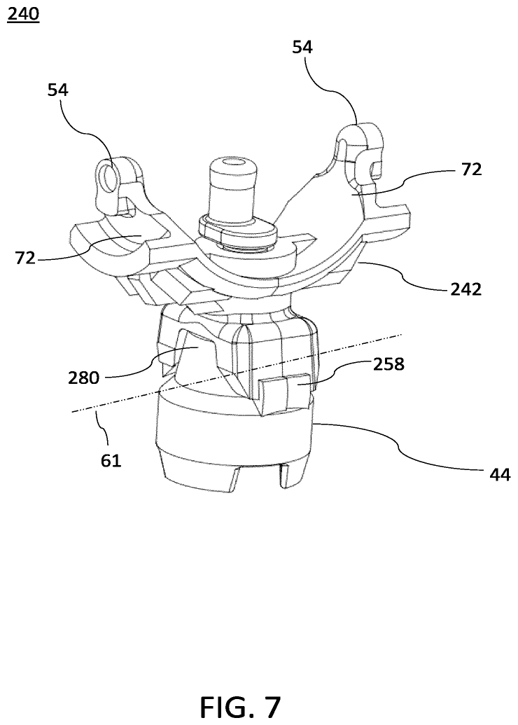

The third example mounting assembly 220 comprises a driving unit 240, also shown in FIG. 7, which is similar to the driving unit 40 of the first example mounting assembly 20. Specifically, the driving unit 240 of this example comprises a frame 242 and a driving axle 44, where the frame 242 is rotatable relative to the driving axle 44, and which provides a bearing surface 252 for the driving axle 44. The driving axle 44 is similar to the driving axle 44 in the first example mounting assembly 20.

The frame 242 comprises two arms 72 with body couplings 54 which are similar to the body couplings 54 in the first example mounting assembly 20, and which pivotably couple the frame 242 to the body 26 of the head 24. The frame 242 in this example differs from the frame 42 in the first example in that it comprises a base coupling 258 having different protrusions to the pins.

The driving unit 240 of this example differs from the driving unit 40 of the first example mounting assembly 20 in that the two opposing protrusions on the frame 242 which act as the base couplings 258 each define a surface curved in a plane perpendicular to the primary axis 50 (e.g., the cross-sectional plane shown in FIG. 6). The protrusions interface with, and bear against, the channels in the base 222, thus permitting pivoting movement of the base coupling 258 about the primary base axis 61, which is parallel to the primary axis 50, and permitting translating movement of the base coupling 258 along the channels.

The base coupling 258 comprises a void 280 (best shown in FIG. 7) between the frame 242 and the base 222 so as not to obstruct pivoting movement of the frame 242 relative to the base 222 about the secondary base axis 62, thereby permitting pivoting movement of the frame 242 relative to the base 222 about the secondary base axis 62.

Each of the examples therefore permits pivoting movement of the head about the primary axis 50 and the secondary axis 70, and connects the driving unit 40, 140, 240 to the head 24 and the base 22, 122, 222 to permit pivoting movement about the body pivot axis 56, the primary base axis 61, and the secondary base.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A mounting assembly for a hair cutting appliance, the mounting assembly comprising:
a base and a head, the head comprising a body and a driving bridge and being configured to receive a cutting unit, wherein the driving bridge is configured to couple to the cutting unit and to reciprocally move relative to the body;
a pivoting mechanism disposed between the head and the base and configured to permit pivoting movement of the head relative to the base about a primary axis and a secondary axis; and
a driving unit comprising a frame and a driving axle, wherein the frame is rotatable relative to the driving axle about an elongate axis of the driving axle, and provides a bearing surface for the driving axle;
wherein the frame comprises a body coupling which is configured to couple to the body of the head to permit pivoting movement of the head relative to the frame about a body pivot axis which is parallel to the primary pivot axis, and wherein the driving unit comprises a base coupling which is configured to couple to the base to permit pivoting movement of the frame relative to the base about a base axis which is parallel to the secondary axis;
wherein the driving axle comprises:
an eccentric driving pin at a distal end of the driving axle, the eccentric driving pin configured to interact with the driving bridge to induce reciprocating movement to the driving bridge relative to the body of the head; and
a socket on a proximal end of the axle for engaging with a driving head on a motor axle for rotary transmission.

2. A mounting assembly according to claim 1, wherein the frame comprises the base coupling which is configured to couple to the base to permit pivoting movement of the frame relative to the base about the base axis.

3. A mounting assembly according to claim 1, wherein the base axis is a secondary base axis; and
wherein the base coupling is further configured to couple to the base to permit pivoting movement of the frame relative to the base about a primary base axis which is parallel to the primary axis.

4. A mounting assembly according to claim 3, wherein the base coupling is further configured to translate in a direction away from, or towards, the head.

5. A mounting assembly according to claim 1, wherein the frame comprises a protrusion which acts as the base coupling, and which is configured to cooperate with a channel in the base extending away from the head, to permit pivoting movement of the frame relative to the base about the primary base axis, and to permit translating movement of the protrusion along the slot or channel.

6. A mounting assembly according to claim 5, wherein there are two opposing protrusions which each cooperate with respective opposing channels in the base.

7. A mounting assembly according to claim 5, wherein the protrusion is a pin configured to cooperate with a slot in the base.

8. A mounting assembly according to claim 7, wherein the base coupling is configured such that the pin of the base coupling is disposed within the slot, and such that the pin can be translated along the slot to accommodate pivoting movement of the head about the primary axis, and into and out of the slot to permit pivoting movement about the secondary base axis.

9. A mounting assembly according to claim 6, wherein the two opposing protrusions define a surface curved in a plane perpendicular to the primary axis which interfaces with, and bears against, the channel to permit pivoting movement of the base coupling about the primary base axis.

10. A mounting assembly according to claim 9, wherein the base coupling comprises a void between the frame and the base so as not to obstruct pivoting movement about the secondary base axis, thereby permitting pivoting movement about the secondary base axis.

11. A mounting assembly according to claim 4, wherein the pivoting mechanism comprises a four-bar linkage comprising two arms pivotably disposed between the head and the base such that each of the head, the base and each arm is one arm of the four-bar linkage, such that the primary axis is a virtual axis.

12. A mounting assembly according to claim 1, wherein the frame comprises a pair of opposing body couplings which are configured to permit pivoting movement of the frame relative to the head about the body pivot axis which passes through both body couplings.

13. A mounting assembly according to claim 12, wherein the body couplings of the frame each comprise an arm, each arm having a distal pin or a hole, the pin or hole cooperating with a corresponding hole or pin in the body of the head to permit pivoting movement about the body pivot axis through the pins and holes, and wherein the arms are configured such that they are held under pretension to push the respective pins and holes together.

14. A mounting assembly according to claim 1, wherein the frame is suspended from the body of the head at the body couplings.

15. A hair cutting appliance comprising a mounting assembly according to claim 1, and a handle fixed to the base of the mounting assembly, the handle comprising a motor to rotate an elongate motor axle, the elongate motor axle comprising a driving head at a distal end which is coupled to the socket of the driving axle of the mounting assembly to form an articulated joint configured to transfer rotary motion from the motor axle to the driving axle, and configured to permit pivoting movement between the motor axle and the driving axle.
